(19) United States
(12) Patent Application Publication
(10) Pub. No.: US 2004/0242817 A1
(43) Pub. Date: Dec. 2, 2004

(54) Internally coordinated organoboranes

(75) Inventors: Jonathan L. Kendall, Apex, NC (US); Kirk J. Abbey, Garner, NC (US)

Correspondence Address: LORD CORPORATION, PATENT & LEGAL SERVICES, 111 LORD DRIVE, CARY, NC, 27512, US

(73) Assignee: Lord Corporation

(21) Appl. No.: 10/447,711

(22) Filed: May 29, 2003

(51) Int. Cl. C08F 2/00

(52) U.S. Cl. 526/217; 526/319; 156/327; 156/331.5

(57) ABSTRACT

Disclosed are internally coordinated organoboranes as 5, 6, or 7-membered rings formed from an unsaturated amine, amidine, or guanidine and dialkylhydroborane under hydroboration conditions, as well as two-part adhesive or coating kits containing radical polymerizable material and the internally coordinated organoborane. A representative internally coordinated organoborane is:

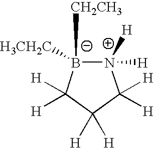

### FIELD OF THE INVENTION

The invention is directed to internally coordinated organoborane initiators and oxygen-activated adhesives and coatings containing the internally coordinated organoborane initiators which cure via radical polymerization.

### BACKGROUND OF THE INVENTION

There have been a number of reports of acrylic structural adhesives employing organoboranes as the initiator. A structural adhesive containing acrylic monomer(s) and a peroxide-activated triarylborane, e.g. triphenylborane, complex with hydroxide, ammonia, benzene, or an amine is reported in British Patent Specification No.1,113,722 published May 15, 1968. A dental resin composed of tributylborane-amine complexes in methyl methacrylate and activated with isocyanates, acid chlorides, or sulfonyl chlorides was reported in 1969 (Fujisawa, S. et al. Iyo Kizai Hokoku, Tokyo Ika Shika Daigaku 1969, 3, 64-71.) Acrylic adhesives polymerized with tributylborane and other trialkylboranes have also been reported. (See, U.S. Pat. No. 3,527,737 to Masuhara, et al. and GDR Pat. No. 2,321,215 to Masuhara, et al.). Japanese Patent App. 69-100477 (1972) disclosed a simple adhesive containing methyl methacrylate (MMA), tributylborane, and poly-MMA for use in the bonding of polyolefins or vinyl polymer articles. Excellent tensile shear strengths of over 1800 p.s.i. (12,420 kPa) were reported. This form of organoborane is not practical from a commercial standpoint.

Two-part adhesives utilizing in one part trialkyl, triphenyl, or alkylphenylborane externally coordinated complexes with a primary or secondary amine and in the other part an organic acid or aldehyde are reported in U.S. Pat. No. 5,106,928, Can. Patent 2,061,021, U.S. Pat. No. 5,143,884, U.S. Pat. No. 5,310,835, and U.S. Pat. No. 5,376,746.

Similar external amine-blocked organoboranes are disclosed in U.S. Pat. Nos. 5,539,070, 5,690,780, 5,691,065, and 6,248,846, but with a nitrogen-to-boron ratio of 1:1 to 1.5:1. These patents also note useful bonding to low surface energy materials such as polyolefins and polytetrafluoroethylene. U.S. Pat. Nos. 5,621,143, 5,681,910, and 5,718,977 disclose a polyoxyalkylenepolyamine-blocked organoborane initiator. Organoborane initiators for acrylic adhesives have also been externally complexed with amidines (U.S. Pat. No. 6,410,667, U.S. Patent Pub. US 2002/0182425, and WO 01/32717) and hydroxides and alkoxides (Intl. Patent Appl. WO 01/32716 and U.S. Pat. No. 6,486,090).

The problem of air stability of organoborane complexes has long been recognized as trialkylboranes rapidly react with oxygen (the lower molecular weight compounds being pyrophoric). Frankland reported the synthesis of triethylborane and its air-stable complex with a Lewis base, e.g. ammonia, in 1863 (Phil. Trans. Royal Soc. 1863,152,167-183). The amine complex is believed to slow down the oxidation of organoboranes by blocking the borane open site for oxygen binding, which is the first step in the reaction of organoboranes with oxygen. Much of the prior art has used this approach of stabilizing the organoborane initiator by forming a complex with an external Lewis base. The compound is then activated with an acid stronger than the organoborane.

Mikhailov, B. M., Dorokhov V. A., and Mostovi, N. V. reported in Bull. Acad. Sci. USSR Div. Chem. Sci. (Engl. Transl.) 1964, 186-188 the preparation of dibutyl(3-aminopropyl)borane, and dipropyl(3-aminopropyl)borane by the addition of diborane to allylamine. Mostovoi, N. V., Dorokhov V. A., and Mikhailov, B. M. reported in Bull. Acad. Sci. USSR Div. Chem. Sci. (Engl. Transl.) 1966, 70-75 the preparation of dibutyl(N,N-dimethyl-3-aminopropyl)borane and dibutyl(N,N-diethyl-3-aminopropyl)borane.

The technical problem encountered in providing commercially useful adhesives and coatings using a blocked organoborane lies in increasing the shelf stability while at the same time not sacrificing cure speed. Currently offered products require storage at no more than 4° C., a condition which presents significant cost and logistical problems. There remains a desired objective for providing air-curable materials that are shelf-stable at or near room temperature, obviating the need for low temperature storage and handling.

### SUMMARY OF THE INVENTION

In accordance with a first aspect of the invention there are provided internally coordinated organoboranes (I)-(VII):

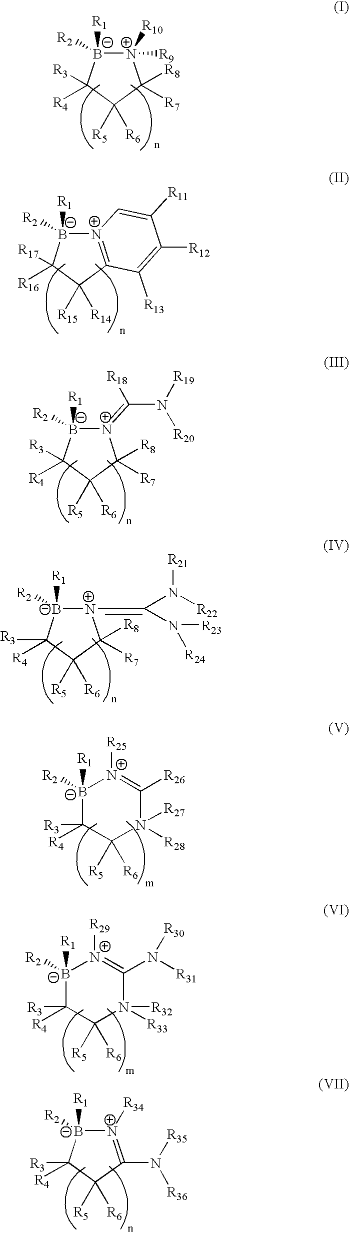

wherein, wherever occurring, n is 1, 2, or 3; m is 1 or 2; R₁ and R₂ are independently selected from substituted or unsubstituted, linear or branched C₁-C₁₂ alkyl, phenyl, benzyl, C₁-C₈ linear or branched alkyl (mono-, di-, or tri-) substituted aryl;

R₉ and R₁₀ are independently hydrogen, substituted or unsubstituted C₁-C₆ linear or branched alkyl groups, with the proviso in (I) in this first aspect of the invention where n=1, one of R₉ and R₁₀ is H and the other is a C₁-C₆ linear or branched alkyl;

R₃-R₈ and R₁₁-R₁₇ are each independently hydrogen, substituted or unsubstituted C₁-C₁₂ alkyl, phenyl, C₁-C₈, linear or branched alkyl (mono-, di-, or tri-) substituted aryl group or a fused aromatic ring, or where two groups together form a ring structures;

R₁₈-R₃₆ are independently hydrogen, substituted and unsubstituted C₁-C₁₂ alkyl, C₁-C₈ linear or branched alkyl (mono-, di-, or tri-) substituted aryl group, or where two groups together form a ring structure. “Cyclic coordinated” means boron and a nitrogen atom are part of the cycle. Any substituents on a single atom can comprise a spiro ring; any two substituents on adjacent atoms may comprise a ring, or any substituent among R₃-R₈ together with a substituent from among R₉-R₃₆ can form a ring, except in cases of a severely strained ring configuration.

In accordance with a second aspect, a two-part, oxygen-promoted curable kit comprising in one part a radical polymerizable material and at least one internally blocked 5-, 6- or 7-membered cyclic coordinated organoborane amine, amidine, or guanidine which contains a nitrogen-boron coordinate bond as part of the cycle, and in the other part, a deblocking agent and optional radical polymerizable material. The cyclic nitrogen coordinated with boron is derived from a primary, secondary, tertiary unsaturated amine, unsaturated amidine, or unsaturated guanidine.

In accordance with a third aspect of the invention, which is a preferred embodiment, there is a two-part, oxygen-promoted kit comprising in a first part a radical-polymerizable material and deblocking agent, and the second part comprising at least one internally coordinated organoborane amine, amidine, or guanidine, optional polymerizable material, and an optional liquid carrier. The kit according to the preferred third aspect contains optional additives for each part, including but not limited to at least one of a reactive diluent, non-reactive diluent, toughener, filler, rheological control agent, adhesion promoter, oligomer and/or polymer component.

In accordance with a fourth aspect of the invention there is provided a two-part, oxygen-promoted curable kit, where a first part comprises a polymerizable component, optional deblocking agent, optional accelerator, and a non-borane free radical initiator; and the second part comprises at least one internally coordinated organoborane amine, amidine, or guanidine, and optional radical polymerizable material and/or liquid carrier.

In accordance with a fifth aspect of the invention there is provided a method for adhesively bonding two substrates together to form a bonded composite, the method comprising the steps of:

(a) providing a first substrate and a second substrate of the same material composition or a different material composition;

(b) applying to at least one of said substrates the following materials a mixture comprising:

(i) at least one radical polymerizable material;

(ii) a deblocking agent, optional accelerator and/or optional non-borane free radical initiator; an effective amount of an internally coordinated organoborane amine, amidine, or guanidine;

(c) contacting the first substrate with the second substrate with the mixture of step (b) therebetween; and

(d) curing said mixture in air at ambient conditions with the optional application of heat, whereby the first and second substrates are adhesively bonded together.

In another embodiment of the fifth aspect of the invention one or both of the substrates is pre-treated prior to applying the mixture.

In a sixth aspect the invention there is provided a method for treating a substrate comprising applying a radical polymerizable material in admixture with an activated internally coordinated organoborane amine, amidine, or guanidine in an inert organic solvent as a primer followed by addition of an overcoat on the primer-applied substrate.

In a seventh aspect the invention includes a method for coating a substrate comprising applying a liquid mixture comprising a radical polymerizable composition and an internally coordinated organoborane amine, amidine, or guanidine to a thickness ranging from 0.0005-0.050 in. (0.12-1.27 mm) and curing said mixture to a solid protective coating.

The internally coordinated organoboranes of the present invention exhibit improved air stability in the blocked state as compared to conventional organoborane-amine complexes, yet undergo rapid initiation of radical polymerization in the unblocked state upon exposure to air. The internally coordinated organoboranes comprise boron as part of the internal ring structure with two of the four available boron valences forming part of a ring with the boron-coordinating nitrogen. The substituents R₁-R₃₆ in (I)-(VII) or substituents on R₁-R₃₆ hydrocarbyl groups cannot be groups that will tend to de-complex the organoborane nor groups that would tend to complex with un-blocked boron. However, such substituents which can be deactivated towards boron coordination, such as by way of reaction with the deblocking agent are envisioned, e.g., further basic groups which interact with acids. Excluded substituent groups include ester, alkoxy, alkoxycarbonyl and acidic groups such as carboxy or sulfonyl acids and acid halides.

### DETAILED DESCRIPTION OF THE PREFERRED EMBODIMENTS

The curable compositions are useful for forming adhesive bonds between two substrates or for coating a substrate. In general, a two-part kit comprises:

(i) a radical polymerizable material; and

(ii) an internally coordinated organoborane comprising nitrogen bonded to boron as part of a 5-, 6-, or 7-membered ring. Components (i) and (ii) can be in the same part or in different parts. The preferred two-part kit further comprises a deblocking agent in the part which does not contain the organoborane. In a specific embodiment according to the second aspect, a first part (part A) comprises a radical polymerizable material and an internally coordinated organoborane which contains a nitrogen coordinated with boron in a 5-, 6-, or 7-membered ring, and the second part (part B) comprises a deblocking agent and a carrier. A carrier can be used to dissolve or disperse the internally coordinated organoborane. The carrier can be used to dissolve or disperse the deblocking agent. The carrier may be reactive, such as a liquid monomer, oligomer or so-called reactive diluent, or a non-reactive diluent, such as an inert carrier liquid, e.g., a plasticizer. The two parts of the kit are combined by mixing and the mixture is dispensed on one or both substrates as in the case of adhering two substrates, or coated onto a substrate in the case of coatings. Mixing causes contact of the deblocking agent with the organoborane, which, in the presence of air, gives initiation of polymerization and curing of the liquid mass via free radical polymerization. The internally coordinated organoborane is prepared by reacting a dialkyl hydroborane with an olefinic unsaturated amine, amidine, or guanidine under hydroboration conditions.

As starting materials, unsaturated (olefinic) amines can be cyclic or acyclic, primary, secondary or tertiary amines. Representative unsaturated amines include, allylamine, homoallylamine, N-methyl-N-allylamine, allyldimethylamine, methallylamine, N-ethyl-2-methallylamine, 2-allylpyridine, 2-(2-propenyl)pyridine, 2-(2-propenyl-4-dimethylamino)pyridine, N-allylcyclopentylamine, N-allylaniline, allylcyclohexylamine, 2-isopropenylaniline, N,N,N′,N′-tetramethyl-2-butene-1,4-diamine, N,N′-diethyl-2-butene-1,4-diamine, and N-ethyl-2-methylallylamine. Representative unsaturated amidine compounds include:

2-vinyl-4,5-dihydro-1H-imidazole (prepared by methods disclosed in DE 2522226);

N-Vinyl-N,N′-diisobutylformamidine (prepared by methods disclosed in DE 1155772);

N-allyl-N,N′-dimethylformamidine (prepared by methods disclosed in Oszczapowicz, Janusz; Ciszkowski, Konrad; JCPKBH; J.Chem.Soc.Perkin Trans.2; EN; 1987; 663-668);

N′-allyl-N,N-dimethyl-propionamidine (prepared by methods disclosed in Oszczapowicz, Janusz; Ciszkowski, Konrad; JCPKBH; J.Chem.Soc.Perkin Trans.2; EN; 1987; 663-668);

N′-allyl-2,N,N-trimethylpropionamidine (prepare by methods disclosed in Oszczapowicz, Janusz; Ciszkowski, Konrad; JCPKBH; J.Chem.Soc.Perkin Trans.2; EN; 1987; 663-668);

N′-allyl-2,2,N,N-tetramethylpropionamidine (prepared by methods disclosed in Oszczapowicz, Janusz; Ciszkowski, Konrad; JCPKBH; J.Chem.Soc.Perkin Trans.2; EN; 1987; 663-668), and

vinyligous amidines such as 2-allyl-4-dimethylaminopyridine.

Representative unsaturated guanidine and biguanidine compounds include:

N-(2-methyl-allyl)-guanidine (See BE Patent 631159; 1963);

N-allyl-N′,N′-dimethyl-guanidine (See BE Patent 667875; 1966);

1,1-diethyl-2-allylbiguanidine (See DE 2117015; 1972);

and biguanidines disclosed in U.S. Pat. No. 3,960,949.

There may be a mixture of isomers in the starting unsaturated compound, in which case more than one internally coordinated organoborane results.

In accordance with preferred aspects of the invention the cyclic coordinated organoboranes have the structures (I)-(VII)

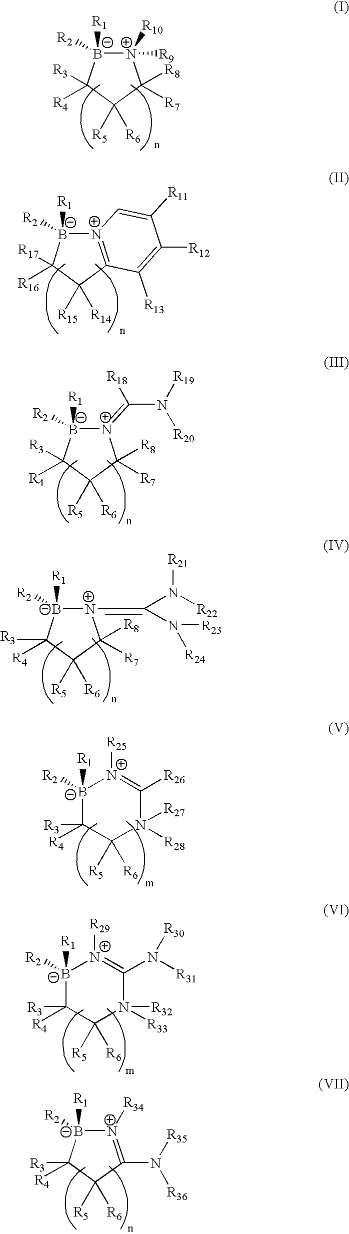

wherein for (I)-(VII) n is 1, 2, or 3; m is 1 or 2; R₁ and R₂ are independently selected from substituted or unsubstituted, linear or branched C₁-C₁₂ alkyl, phenyl, benzyl, and C₁-C₈ linear or branched alkyl (mono-, di-, or tri-) substituted aryl group. Exemplary R₁ and R₂ groups are methyl, ethyl, propyl, butyl, pentyl, hexyl, heptyl, octyl, nonyl and decyl, or branched C₁-C₁₂ alkyl groups, e.g., isopropyl, isobutyl, neopentyl, methylhexyl, etc. Preferably R₁ and R₂ are linear alkyl groups having from 2 to 5 carbon atoms, e.g., ethyl, propyl, n-butyl, and pentyl. More preferably R₁ and R₂ are ethyl groups. It is understood where n=2 or 3, and m=2, additional ring carbons may bear substituents as defined for R₅ and R₆.

R₉ and R₁₀ are independently H, substituted or unsubstituted C₁-C₆ linear or branched alkyl groups, with the proviso in the first aspect in structure (I), where n=1, one of R₉ and R₁₀ is H and the other is C₁-C₆ linear or branched alkyl. Examples of alkyl groups as R₉ and R₁₀ include methyl, ethyl, n-propyl, n-butyl, sec-butyl and isopropyl. A more preferred structure is (I) wherein n=1, R₁ is ethyl, R₂ is ethyl, one of R₉ and R₁₀ is H, and the other is methyl or ethyl, and R₃, R₄, R₆, R₇ and R₈ are H, and R₅ is methyl or H.

R₃-R₈ and R₁₁-R₁₇ are each independently hydrogen, substituted or unsubstituted C₁-C₁₂ alkyl, phenyl, C₁-C₈ linear or branched alkyl (mono-, di-, or tri-) substituted aryl group, a fused aromatic ring, or two groups together form a cyclic group;

R₁₈-R₃₆ are independently hydrogen, substituted or unsubstituted C₁-C₁₂ alkyl, substituted or unsubstituted C₁-C₈ linear or branched alkyl (mono-, di-, or tri-) substituted aryl group and two such groups together may form one or more cyclic structures. Two substituents from among R₃-R₃₆ on a single atom can be linked to form a spiro ring; or two substituents among R₃-R₃₆ that are on adjacent atoms may comprise a ring structure, or any substituent among R₃-R₈ together with a substituent from among R₉ -R₃₆ can form a bridging ring, except in cases of a severely strained ring configuration.

Preferably for (I)-(VII), R₁ and R₂ are ethyl groups. Preferably, R₉ and R₁₀ are independently hydrogen, or C₁-C₅ alkyl. Specific preferred examples of (I) are (Ia), (Ib) and (Ic):

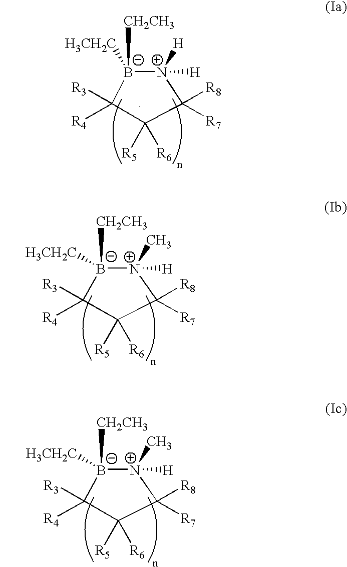

wherein n=1 or 2 and R₃-R₈ are independently H or C₁-C₅ alkyl.

A specific preferred example of (I) is (Id):

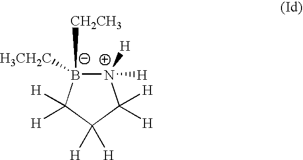

A representative spiro ring substituent on the internal cyclic organoborane is:

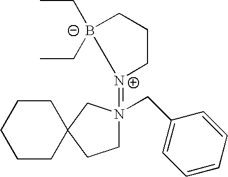

and is prepared by reacting allyl-(2-benzyl-2-aza-spiro[4.5]dec-1-ylidene)-amine with diethylhydroborane under hydroboration conditions.

R₃-R₈, and R₁₁-R₁₇ by way of example are independently H, linear alkyl groups e.g., methyl, ethyl, propyl, butyl, pentyl, hexyl, heptyl, octyl, nonyl and decyl, or branched C₁-C₁₀ alkyl groups, e.g., isopropyl, isobutyl, neopentyl, methylhexyl, etc. Preferably, R₃-R₈, and R₁₁-R₁₇ are H, alkyl groups having 1 to 5 carbon atoms such as methyl, ethyl, propyl, iso-propyl, n-butyl, isobutyl, and pentyl;

R₁₈-R₃₆ in (III) to (VII) are independently hydrogen, C₁-C₁₂ alkyl, C₁-C₈ linear or branched alkyl (mono-, di-, or tri-) substituted aryl group. Any two groups of R₁₈-R₃₆ may form one or more cyclic structures. R₁₈-R₃₆ are preferably not aryl groups.

Substituents on any alkyl, phenyl ring, benzyl ring, alkyl substituted aryl, or fused ring can be hydrocarbyl groups such as alkyl or aryl groups containing no substituent groups that will destabilize the B-N bond or interact with unblocked boron, that is, substituents that do not de-complex the cyclic coordinated organoborane or form complexes with activated boron. However, such substituents which are deactivated towards boron coordination, such as by way of reaction with the deblocking agent are envisioned, e.g., further basic groups which interact with acids. Excluded substituent groups include ester, alkoxy, alkoxycarbonyl and acidic groups such as carboxy or sulfonyl acids and acid halides.

In the following examples of (I) and (II) the moiety illustrated as

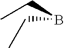

denotes two CH₃CH₂— groups bonded to a boron atom. The following structures depict coordinate B-N bonds as positive and negative charged centers which can also be represented by an arrow denoting a coordinate bond. Specific examples are illustrated by the following structures. Lines depict C—C bonds and junctions are CH or CH₂ groups:

(i) diethyl(3-aminopropyl)borane

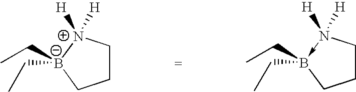

(ii) diethyl(N-methyl-4-aminobutyl)borane

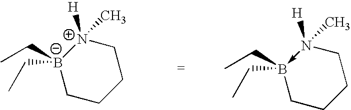

(iii) diethyl(N,N-dimethyl-3-aminopropyl)borane

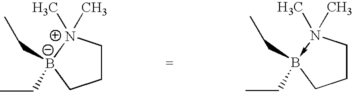

(iv) diethyl(4-aminobutyl)borane

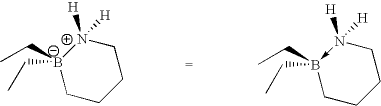

(v) 2-(2-(B,B-diethylboranyl)isopropyl)pyridine

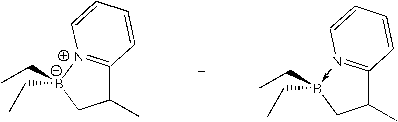

(vi) 2-(3-(B,B-diethylboranyl)propyl)pyridine

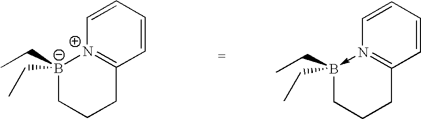

(vii) 2-(2-(B,B-diethylboranyl)isopropyl)-4-dimethylaminopyridine

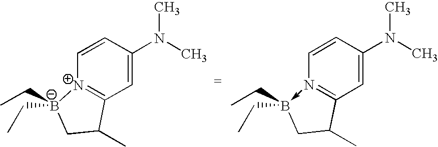

(viii) 2-(3-(B,B-diethylboranyl)propyl)-3-dimethylamino pyridine

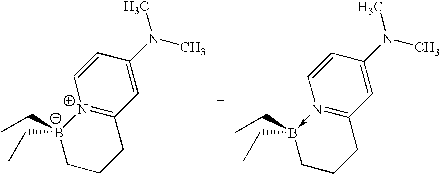

The process of making the internally coordinated organoborane comprises forming a dialkylhydroborane and reaction of the dialkylhydroborane with an unsaturated amine, amidine, or guanidine. The dialkylhydroborane exists in an equilibrium mixture of borane and trialkylborane. A dialkyhydroborane can be formed on mixture of trialkylborane and borane-dimethylsulfide, or mixture of trialkylborane and borane-THF. “Alkyl”0 in this context has the same meaning as R₁ and R₂ in the above structures (I)-(VII). The dialkylhydroborane reacts under hydroboration conditions with an unsaturated amine, unsaturated amidine or unsaturated guanidine (the term guanidine used herein is inclusive of diguanidine).

One method to make an internally coordinated organoborane is a 2-step, 1-pot method of combining trihydro[thiobis[methane]]-borane and triethylborane. Dimethylsulfide is separated as waste. Diethylhydroborane formed in the first step is reacted under hydroboration conditions with the unsaturated amine, amidine, or guanidine coordinating compound. In the preferred embodiments the unsaturated coordinating compound contains an amine group and terminal olefin group which forms a 5-, 6-, or 7-membered internally coordinated organoborane. Being under hydroboration conditions means what is commonly understood in the art of reacting an olefin with a compound that contains a B-H linkage under inert atmosphere (e.g. argon) and in a solvent which is non-interfering, such as an ether, and excluding alcohol, in a temperature range of from −40 to +40° C. The preferred reaction temperature range is +10 to +30° C. Tetrahydrofuran is a preferred solvent.

As a polymerizable coating or adhesive, a radical polymerizable material is contacted with an effective amount of the internally coordinated organoborane. In embodiments not cured by heat alone, a selected acidic radical polymerizable material can be employed as the deblocking agent to activate the internally coordinated organoborane. In other embodiments, a non-polymerizable deblocking agent is used. The effective amount of organoborane is an amount that is sufficient to permit polymerization of a radical polymerizable material to a solid polymer. Any combination of liquid and solid radical polymerizable materials can be employed. A useful range of organoborane initiator is from 1 to 10 parts per 100 wt. parts of polymerizable materials. If the amount of internally coordinated organoborane is too high, then the polymerization may proceed too rapidly to allow for effective mixing and application of the composition to the substrate(s). The useful rate of polymerization will depend in part on the method of applying the composition to the substrate. Thus, the rate of polymerization for a high speed automated industrial applicator can be faster than if the composition is applied with a hand applicator or if the composition is mixed manually. Adhesive formulations containing an amount of internally coordinated organoborane, on a molar basis from about 0.5 mol % to about 20 mol % based on the moles of radical polymerizable material(s) provides useful results. Good adhesive bond strength is obtainable using acrylic polymerizable components with from 1.5 to 8 mol % of internally coordinated organoborane initiator.

When a deblocking agent is employed, on contact with the internally coordinated organoborane, the coordinate B-N bond is disrupted de-shielding the boron atom, and upon interaction with oxygen, radicals are generated to initiate the curing of a polymerizable composition. Heat, in the absence of a deblocking agent will also initiate curing. Suitable deblocking agents that activate by de-complexing the organoborane initiator include acids, acid chlorides, anhydrides, alkylating agents, and ethylenic unsaturated compounds containing such moieties. Acids or acidic groups can be selected which also provide an accelerator function. Accelerators are optional. Useful acids which de-block the organoborane include Lewis acids (e.g., BF₃ lanthanum triflate, and the like), Brönsted acids, and combinations thereof. Brönsted acids include monofunctional acids having the general formula R′—COOH, where R′ is hydrogen, an alkyl group, or an alkenyl group of 1 to 12 and preferably 1 to 6 carbon atoms, or an aryl group of 6 to 10, preferably 6 to 8 carbon atoms; and sulfonic acids (R—SO₃H) for example, where R is alkyl or aryl . Carboxylates having more than one acidic moiety or those known as activated carboxylic acids can be used. The alkyl and alkenyl groups on a monofunctional carboxylic acid used as a deblocking agent may comprise a straight chain or they may be branched. Such groups may be saturated or unsaturated. The aryl groups may contain substituents such as alkyl, alkoxy or halogen moieties. Specific examples as illustrative acids of this type include methanesulfonic acid, toluene sulfonic acid, dichloroacetic acid, trichloroacetic acid, oxalic acid, maleic acid, and p-methoxybenzoic acid. Other useful Brönsted acids include HCl, H₂SO₄, H₃PO₄, HBF₄, and the like. Preferred deblocking agents are sulfonic acids, and trichloroacetic acid.

The deblocking agent should be used in an amount effective to deblock the internally coordinated organoborane. If too little deblocking agent is employed, the rate of polymerization may be too slow and the monomers that are being polymerized may not adequately convert to a fully cured polymer. However, a reduced amount of deblocking agent may be helpful in slowing the rate of polymerization. If too much deblocking agent is used, then the polymerization may proceed too quickly and, in the case of adhesives, the resulting cured adhesive may demonstrate inadequate adhesion, particularly to low energy surfaces. On the other hand, an excess of deblocking agent may be useful for attaining good adhesion. Within these parameters, the deblocking agent preferably is provided in an amount of about 30 to 540 mole % based on the number of equivalents of internally coordinated organoborane, more preferably about 90 to 350 mol %, and most preferably about 150 to 250 mol % based on the equivalents of borane initiator functionality.

Adhesives and coating formulations can contain in addition to (I)-(VII), optionally another different internally coordinated organoborane, or a conventional external coordinated organoborane, such as a conventional external amine organoborane complex or a non-borane free radical initiator. A non-borane free radical initiator can readily be contained in the polymerizable monomer part of a two-part polymerizable composition. Preferred non-borane free radical initiators are those which do not readily react with monomer under shelf-aging conditions, or can be inhibited suitably to provide desired shelf stability of up to several months, if needed.

Illustrative examples of suitable non-borane free radical initiators optionally employed in combination with the polymerizable monomers described above include organic hydroperoxy initiators, particularly those organic hydroperoxides having the formula R″OOH wherein R″ is a hydrocarbon radical containing up to about 18 carbon atoms, preferably an alkyl, aryl, or aryl alkyl radical containing from one to 12 carbon atoms. Specific examples of such hydroperoxides are cumene hydroperoxide, tertiary butyl hydroperoxide, methyl ethyl ketone peroxide, and hydroperoxides formed by the oxygenation of various hydrocarbons, such as methylbutene, cetane, and cyclohexene, and various ketones and ethers. Other examples of useful initiators include hydroperoxides such as p-menthane hydroperoxide, 2,5-dimethylhexane, 2,5-dihydroperoxide and the like. Additionally, more than one non-borane free radical initiator may be employed, such as a mixture of hydroperoxides with peresters, such as t-butyl perbenzoate or t-butyl-peroxymaleate, can be advantageously used. For reasons of economics, availability, and stability, cumene hydroperoxide is especially preferred.

The two part adhesive kit embodiments of the second aspect of the invention comprises in part A at least one polymerizable (meth)acrylate monomer and an internally coordinated organoborane amine, amidine, or guanidine, and part B comprises a deblocking agent and a liquid carrier. In the preferred third aspect, monomer and deblocking agent are combined in part A, and part B comprises the internally coordinated organoborane. Part A and B are mixed at the time of dispensing whereby curing takes place by the action of the deblocking agent on the internally coordinated organoborane. In the second aspect, part A comprises at least one polymerizable (meth)acrylate monomer and the internally coordinated organoborane amine, amidine, or guanidine, and part B comprises a deblocking agent and additional polymerizable material, such that a 1:1 to 4:1 volume mixture of parts A and B are provided.

The radical polymerizable monomer materials are known in the art of acrylic structural adhesives. The terms “acryl” and “acrylate” used herein are inclusive of the substituted acrylates, e.g., “methacryl” and “methacrylate”. Any suitable liquid radical polymerizable monomer useful for forming structural adhesives or coatings can be utilized in the two-part kits according to the present invention. Preferably, of the radical polymerizable monomer compounds, there is a primary monomer in major wt. % of polymerizable materials as substituted or unsubstituted monoethylenic unsaturated carboxylate acid ester. There is no limitation with respect to the polymerizable monomer(s) used. Preferred monounsaturated monomers include acrylic and methacrylic esters such as methylmethacrylate, tetrahydrofurfurylmethacrylate, C₇-C₁₀ alkyl methacrylates such as bornyl (C₁₀-H₁₇) methacrylate and isobornyl methacrylate; substituted cyclohexyl methacrylates such as C₃-C₁₀ alkyl monosubstituted cyclohexylmethacrylate, C₁-C₆ alkyl disubstituted cyclohexylmethacrylate, C₁-C₄ alkyl tri-substituted cyclohexylmethacrylate, and C₁-C₄ alkyl tetra-substituted cyclohexylmethacrylate. In one embodiment adhesive or coating, a combination of major amount of a monounsaturated methacrylate and minor amount of multifunctional acrylate is employed.

Preferably included in a formulation is a reactive diluent such as a half-methacrylate ester of a dibasic acid, e.g., mono-2-(methacryloyloxy)ethyl phthalate.

With respect to adhesives of the third aspect, acidic monomers in minor amounts of less than 50 weight % on the weight of methacrylate ester monomer(s) can be employed in part A. Known acidic monomers include acrylic acid, methacrylic acid, crotonic acid, fumaric acid, maleic acid, 2-methylmaleic acid, itaconic acid, 2-methylitaconic acid, α,β,-methylene glutaric acid, monoalkyl maleates, and monoalkyl fumarates, and salts thereof. Ethylenically unsaturated anhydrides can be employed and include, for example, maleic anhydride, itaconic anhydride, acrylic anhydride, and methacrylic anhydride.

Acrylic- and methacrylic ester derivatives can be included in the polymerizable materials which contain groups such as hydroxy, amide, cyano, chloro, and silane groups. Specific examples include hydroxyethyl methacrylate, hydroxypropyl acrylate, and hydroxypropyl methacrylate. Other derivatives include acrylamide, N-methyl acrylamide, diacetone acrylamide, N-tert-butyl acrylamide, N-tert-octyl acrylamide, N-butoxyacrylamide, gamma-methacryloxypropyl trimethoxysilane, dicyclopentadienyloxyethyl methacrylate, 2-cyanoethyl acrylate, 3-cyanopropyl acrylate, glycidyl acrylate, glycidyl methacrylate, acrylated bisphenol compounds, acrylated organosilanes, dimethylaminoethyl acrylate, dimethylamino methacrylate, 2-(meth)acrylamido-2-methyl-1-propanesulfonic acid, 3-sulfopropyl (meth)acrylate, 2-sulfoethyl(meth)acrylate, 2-phosphoethyl (meth)acrylate, itaconic acid, (meth)acryloyloxyalkoxyalkoxycarbonylphthalic acid, an anhydride of (meth)acryloyloxyalkoxycarbonylphthalic acid, an anhydride of (meth)acryloyloxyalkoxyalkoxycarbonylphthalic acid, an anhydride of dicarboxylic acid, and unblocked and blocked acetoacetoxy functional monomers e.g., acetoacetoxyethyl methacrylate and acetoacetoxyethyl acrylate.

Other vinyl or vinylidene monomers are useful as polymerizable materials alone or in admixture with other polymerizable materials. Common examples include vinylidene chloride, vinylidene fluoride, vinyl acetate, vinyl propionate, vinyl butyrate, vinyl benzoate, vinyl butyral, vinyl chloroacetate, isopropenyl acetate, vinyl formate, vinyl methoxyacetate, vinyl caproate, vinyl oleate, vinyl adipate, methyl vinyl ketone, methyl isopropenyl ketone, methyl alpha-chlorovinyl ketone, ethyl vinyl ketone, hydroxymethyl vinyl ketone, chloromethyl vinyl ketone, allylidene diacetate, unblocked and blocked meta-tetramethylisocyante, unblocked and blocked isocyanto ethyl methacrylate and the like. Those polymerizable materials that tend to de-complex the internally coordinated organoborane appreciably should be maintained in the part which does not contain the internally coordinated organoborane. Experience with trial and error will indicate whether sufficient stability as to any one polymerizable material in particular is seen in activated mixtures in the bonding or coating compositions.

The polymerizable monomer components are predominantly mono-ethylenic functional and can contain up to 10 wt % on weight of the A side, of poly-ethylenic functional compounds. Some of the more common examples are ethylene glycol dimethacrylate, ethylene glycol diacrylate, polyethylene glycol diacrylate, tetraethylene glycol dimethacrylate, diglycerol diacrylate, diethylene glycol dimethacrylate, pentaerythritol triacrylate, trimethylolpropane trimethacrylate, and polyether diacrylates and dimethacrylates, dimethacrylate of bis(ethylene glycol) adipate, dimethacrylate of bis(ethylene glycol) maleate, dimethacrylate of bis(ethylene glycol) phthalate, dimethacrylate of bis(tetraethylene glycol) phthalate, dimethacrylate of bis(tetraethylene glycol) sebacate, dimethacrylates of bis(tetraethylene glycol) maleate, bisphenol A dimethacrylate, and the like.

In one embodiment, the radical polymerizable component of adhesives comprise, based on the total weight of the composition about 10 to 60 wt. % (more preferably about 30 to 50 wt. %) of an alkyl methacrylate, and about 0 to 20 wt. % of an alkyl acrylate.

Also useful in combination with polymerizable materials herein include isocyanate-hydroxyacrylate or isocyanate-aminoacrylate reaction products. Known embodiments are acrylate terminated polyurethanes (acrylourethanes) and polyureides or polyureas.

In some embodiments cure rate moderators are not employed to retard the cure rate of (meth)acrylates. However such modifiers can be used, and include ethylenic unsaturated aromatic monomers, and vinyl aromatic terminated oligomers, and dialkyl itaconates, e.g., dibutyl itaconate. Representative non-limiting aromatic vinyl monomers include styrene, α-chlorostyrene, α-methylstyrene, allylbenzene, phenylacetylene, 1-phenyl-1,3-butadiene, 2-vinylnaphthalene, 4-methylstyrene, 4-methoxy-3-methylstyrene, 4-chlorostyrene, 3,4-dimethyl-alpha-methylstyrene, 3-bromo-4-methyl-alpha-methylstyrene, 2,5-dichlorostyrene, 4-fluorostyrene, 3-iodostyrene, 4-cyanostyrene, 4-vinylbenzoic acid, 4-acetoxystyrene, 4-vinyl benzyl alcohol, 3-hydroxystyrene, 1,4-dihydroxystyrene, 3-nitrostyrene, 2-aminostyrene, 4-N,N-dimethylaminostyrene, 4-phenylstyrene, and 4-chloro-1-vinylnaphthalene.

Adhesive and coatings herein can employ epoxide-functional materials. Epoxy compounds which are suitable for use in the invention are described in U.S. Pat. No. 4,467,071 and can be any monomeric or polymeric compound or mixture of compounds having an average of greater than one 1,2-epoxy groups per molecule. Useful polymeric epoxide compounds have a number average molecular weight from about 300 to about 10,000. Epoxy compounds are well-known, and disclosed in U.S. Pat. Nos. 2,467,171; 2,615,007; 2,716,123; 3,030,336 and 3,053,855. Specific examples include polyglycidyl ethers of polyhydric alcohols such as ethylene glycol, triethylene glycol, 1,2-propylene glycol, 1,5-pentanediol, 1,2,6-hexanetriol, glycerol and 2,2-bis(4-hydroxy-cyclohexyl)propane; the polyglycidyl esters of aliphatic or aromatic polycarboxylic acids, such as oxalic acid, succinic acid, glutaric acid, terephthalic acid, 2,6-naphthalene dicarboxylic acid and dimerized linolenic acid; and the polyglycidyl ethers of polyphenols, such as bisphenol A, 1,1-bis(4-hydroxyphenyl)ethane, 1,1-bis(hydroxyphenyl)isobutane, 2,2-bis (4-hydroxy-t-butylphenyl)propane, 1,5-dihydroxynaphthalene and novolak resins.

Adhesive and coatings of the invention optionally, but preferably include one or more solid or liquid polymeric tougheners. Useful additive amounts can range from 5% to 40% by weight of polymerizable materials employed. A polymeric toughener may or may not contain ethylenic functionality reactive with the polymerizable components. Some embodiments toughen as a result of physically dispersing an elastomer polymer. A combination of curable and non-curable toughener additives can also be employed. Known polymeric tougheners include, for example, polychloroprene, polyalkadiene homopolymer, or copolymer, chlorosulfonated polyolefin, various solid and liquid elastomeric polymeric materials like methacrylated ATBN, methacrylated CTBN, and vinyl terminal liquid diene elastomers. One preferred toughener is prepared by reacting a carboxyl-terminated polybutadiene with glycidyl(meth)acrylate.

Representative liquid olefinic-terminated elastomer tougheners include homopolymers of butadiene; copolymers of butadiene and at least one monomer copolymerizable therewith, for example, styrene, acrylonitrile, methacrylonitrile. A preferred toughener of the type of urethane modified liquid rubber is an olefinic-terminated polyalkadiene that has been reacted with an isocyanate prepolymer as described in U.S. Pat. Nos. 4,223,115; 4,452,944; and 4,769,419, and 5,641,834. Other tougheners include block copolymers containing a elastomer segment having a Tg less than 0° C., triblock copolymers, core-shell copolymers, and the like. SIS, and SBS block copolymers are commercially available under the EUROPRENE®, and Kraton® marks. Other tougheners are known as core-shell copolymers and include ABS, MBS, and MABS polymers as disclosed in the U.S. Pat. Nos. 4,304,709, 3,944,631, 4,306,040 and 4,495,324.

Conventional chain transfer agents may be optionally included in moderating the molecular weight of the resulting polymer in the adhesive or coating, such as mercaptans, polymercaptans, and halogen compounds at generally, from 0% to about 1% by weight, based on the weight of the polymerizable components. Some examples of chain transfer agents include C₄-C₂₀ alkyl mercaptans, mercaptopropionic acid, or esters of mercaptopropionic acid.

As a polymerizable material, besides the various monomers used singly or in combination, polymer-in-monomer syrups can be included as are known in the art. Representative syrups including precursor liquid monomer compounds containing at least one olefinically unsaturated group and their preparations are disclosed in U.S. Pat. Nos. 3,333,025; 3,725,504; and 3,873,640, the entire disclosure of each of which is hereby incorporated by reference.

Adhesives and coatings herein optionally can employ a phosphorus compound as deblocking agent, and/or as providing adhesion promoting characteristics. Preferred is the use of phosphorus compounds solely for adhesion promotion and which contain one or more olefinic groups and one or more P—OH groups. Phosphorus-containing compounds are known from among from the group of derivatives of phosphinic acid, phosphonic acid and phosphoric acid having at least one P—OH group and at least one organic moiety characterized by the presence of an olefinic group, which is preferably terminally located. Such phosphorus-containing compounds can be utilized in amounts generally from about 0.1 to about 10 wt %, preferably about 2 to about 8 percent by weight, based on the total weight of the adhesive composition. If used, these compounds are contained in the side which is absent the internally coordinated organoborane.

Representative phosphorus-containing compounds include, without limitation, phosphoric acid, phosphinic acid, 2-acryloyloxyethyl phosphate, 2-methacryloyloxyethyl phosphate, bis-(2-acryloyloxyethyl)phosphate, bis-(2-methacryloxyloxyethyl)phosphate, methyl-(2-methacryloyloxyethyl)phosphate, ethyl acryloyloxyethyl phosphate, ethyl methacryloyloxyethyl phosphate, methyl acryloyloxyethyl phosphate, di(meth)acryloyloxyalkyl phosphate, (meth)acryloyloxyalkylaryl phosphate, (meth)acryloyloxyalkylaryl phosphonate, (meth)acryloyloxyalkyl thiophosphate, di(meth)acryloyloxyalkyl thiophosphate, (meth)acryloyloxyalkylaryl thiophosphate, (meth)acryloyloxyalkylaryl thiophosphonate, vinyl phosphonic acid, allyl phosphonic acid, diallylphosphinic acid, cyclohexene-3-phosphonic acid, α-hydroxybutene-2 phosphonic acid, 1-hydroxy-1-phenylmethane-1,1-diphosphonic acid, 1-hydroxy-1-methyl-1-disphosphonic acid, 1-amino-1-phenyl-1,1-diphosphonic acid, 3-amino-1-hydroxypropane-1,1-disphosphonic acid, amino-tris(methylenephosphonic acid), gamma-amino-propylphosphonic acid, gamma-glycidoxypropylphosphonic acid, phosphoric acid-mono-2-aminoethyl ester, allyl phosphinic acid, β-methacryloyloxyethyl phosphinic acid, and β-methacryloyloxyethyl phosphinic acid.

Adhesives and coatings herein can also optionally contain an unsaturated polyester resin known in the art as derived from polycarboxylic acids and polyhydric alcohols. Preferably such resin is derived from dicarboxylic acid and dihydric alcohol, with at least one of the acid and alcohol components being unsaturated. Preferred unsaturated polyester resins contain a relatively large number of double bonds and are derived from short chain aliphatic polyhydric polyols, such as ethylene glycol and 1,3-propylene glycol, and short chain unsaturated polybasic acids, such as fumaric acid and maleic acid optionally with C₆ and higher such as 1,6-hexanediol, as well as higher polybasic acids, such as adipic acid and phthalic acid.

Still further adhesive or coating embodiments can optionally contain a polyvinyl alkyl ether. Polyvinyl alkyl ethers are well-known in the art. Polyvinyl alkyl ethers preferably contain 1-8, more preferably 1-4, carbon atoms in the alkyl moiety of the ether.

Although the adhesive of the present invention may take many forms, the most preferred adhesive systems are provided as multipack or two-part adhesive systems where one package or part contains the polymerizable or reactive components and the deblocking agent and a second package or part contains the internally coordinated organoborane. The two parts are mixed together at the time of use in order to initiate the reactive cure. The preferred means for dispensing the adhesive are two-chambered cartridges equipped with static mixers in the nozzle, and for larger scale application, meter mix dispensing equipment. After mixing the individual packages, one or both surfaces to be joined are coated with the mixed adhesive system and the surfaces are placed in contact with each other.

The adhesive systems of the invention may be used to bond like substrates or in cross-bonding different substrates. Substrates bonded together or cross-bonded include metal surfaces, such as steel, aluminum and copper, thermoset polymers, thermoplastic polymers such as polyethylene and polypropylene, reinforced plastics, fibers, glass, ceramics, wood, and the like. Prior to bonding or coating, substrates can optionally be pre-treated according to known pretreatments which are beyond the scope of this disclosure. Such pretreatments include conventional metal treatments like acid or alkali rinsing, phosphatizing, sealing, anodizing, electrogalvanizing, and primer coating. Substrates of thermoplastic polymers can be pre-treated but it is an advantage of the present invention that the polymeric substrates are not pretreated. Pre-treatments include applying chemicals or organic solvents or primers, coupling agents or other surface active agents and/or subjecting the surface thereof to grafting or colloid treatment; to irradiation with UV rays, vacuum discharge treatment, flame treatment, ozone treatment, plasma contact treatment or corona discharge treatment, as are known surface pre-treatments.

The adhesive coatings may be brushed, rolled, sprayed, dotted, knifed, and cartridge-applied. Cartridge application is a preferred form for dispensing such as with a dual chamber cartridge. Adhesive can be applied to one substrate, or both substrates to desired thickness. As with structural bonding acrylic embodiments, a conventional bond-line thickness used with conventional adhesives is suitable. The substrates after bonding can remain undisturbed prior to development of handling strength, or they may be clamped during cure in those installations where relative movement is expected prior to development of sufficient curing to provide handling strength.

Incompressible glass beads can be employed to control bond line thickness, as is taught in U.S. Pat. Nos. 5,487,803 and 5,470,416. The beads may be any hard material, e.g. glass, ceramic, polymeric, and may be non-spherical but preferably are spherical in shape. The beads should have a diameter sufficiently low to provide a strong joint and sufficiently high such that the beads are effective for control of bond thickness. Useful bead diameter ranges from 0.003 to 0.030 inches (0.07 to 0.76 mm) with 0.009 in. (0.22 mm) being a preferred diameter. The concentration of beads in the final applied adhesive mixture can range typically from 3% to 20% of the total weight of A- and B-sides.

The invention is particularly useful for adhesively bonding together low surface energy substrates or in cross-bonding a low energy substrate to different substrates. Many low surface energy substrates contain polymers such as polyolefins, and are understood as having surface energies approximately less than 45 mJ/m², especially less than 40 mJ/m² and even less than 35 mJ/m². Included among the known low surface energy substrates are shaped materials containing polyethylene, polypropylene, copolymers of α-olefins, and fluorinated polymers such as polytetrafluoroethylene, and polyvinylidene fluoride. However, the invention is not limited to bonding of low surface energy materials, but is a distinctive feature. Other polymers of relatively higher surface energy that can readily be structurally bonded with the adhesive compositions of the invention include polycarbonate, acrylonitrile-butadiene-styrene, polyamide, polystyrene, SAN, PMMA, phenolic, melamine, polyurea, urethane, epoxy, PVDC, sheet molding compounds, bulk molding compounds, and other thermoset or thermoplastic fiber-reinforced composite materials.

The polymerizable compositions of the invention are effective as contained and dispensed from two-part dispensers. A one-part system may be employed, absent a deblocking agent where curing is effected by heat. An optional accelerator component of the polymerization initiator system can be included. Some accelerators must be kept in a part separate from the internally coordinated organoborane.

As part of a two-part kit according to the third aspect, the internally coordinated organoborane should be contained in a carrier. Carrier vehicles which are suitable can be simple inert solvents or liquid diluents such as methylene chloride, or butyl benzyl phthalate, including mixtures. The carrier vehicle should not contain a borane complex-reactive moiety, such as an acid, an acylating agent or an alkylating agent. The carrier vehicle can be a more complex mixture including at least one film-forming binder in addition to inert solvent or diluent. In this case, the film-forming binder is preferably substantially inert with respect to the organoborane. An exemplary carrier vehicle comprises from about 0.05 to about 50 percent by weight of at least one saturated organic polymeric film-former having a glass transition temperature in the range from about −80° C. to about +150° C. The carrier vehicle can contain in addition to solvent or solvent and film-former, additives such as external plasticizers, flexibilizers, suspending agents, rheological control agents and stabilizers, providing that any such additives do not adversely affect the stability of the internally blocked organoborane.

Specific examples of carriers are plasticizers such as aliphatic and aromatic esters of phthalic acid, aliphatic and aromatic esters of phosphoric acid, aliphatic trimellitate esters, aliphatic esters of adipic acid, as well as stearate, sebacate and oleate esters. Process oils commonly used in the elastomer industry such as aromatic process oil, paraffinic process oil, and napthenic process oil can be used. Liquid polymers such as low molecular weight polyester, low molecular weight polyisobutylene, or silicone oil are suitable.

In a two-part adhesive embodiment, the parts can be mixed as they are dispensed or shortly before applying the mixture to a substrate. In accordance with the second aspect of the invention, an internally coordinated organoborane compound is added to the first part pre-dissolved in an appropriate carrier, such as a monomer. The second part comprises the deblocking agent dissolved in a carrier such as a monomer. Once the two parts are combined, the composition should be used within the pot life which may be on the order of a few minutes to a longer time depending upon cure rate modifier, the internally coordinated organoborane, the polymerizable components, the presence and amount of accelerator, and the temperature of the substrate(s) as applied.

In a typical adhesive embodiment, the mixed initiator/polymerizable composition is applied to one or both substrates and then the substrates are joined together with pressure to ensure full and intimate contact. In general, the bonds should be made within the predetermined open time, prior to skinning over which is usually within about 2 to 20 minutes. The bonding process is advantageously carried out at room temperature and to improve the degree of polymerization it is desirable to keep the temperature at or above room temperature but preferably below about 40° C.

The adhesives according to the invention will cure to a reasonable green strength to permit handling of the bonded components within about 2 to 3 hours at ambient conditions. Full strength will be reached in about 24 hours under ambient conditions; post-curing with heat may be used if desired.

### EXAMPLE 1

### Synthesis of diethyl(3-aminopropyl)borane

In an argon-filled, glove box: to a 100 mL round-bottomed flask fitted with a magnetic stir bar was added 25 mL of borane as a 1M solution in THF (25 mmol) and 8.7 mL (5.9 g, 60 mmol) of triethylborane. The flask was equilibrated for 3 days at −10° C. A 15 mL aliquot of the equilibrated solution (about 33 mmol of diethylborane) was placed in a 50 mL round-bottomed flask equipped with a magnetic stir bar. Over a 45 minute period, 0.2 g aliquots (3.5 mmol) of allyl amine were added to the 50 mL reaction flask until 1.88 g (33.0 mmol) of allyl amine was charged to the flask. After each incremental addition the flask was cooled in a freezer at −10° C. for about 5 min. After all portions of the allyl amine were added, the reaction was allowed to warm to room temperature and was stirred for 2 days. The solvent was vacuum-stripped and the product was vacuum distilled at 1 torr. The first fraction collected at room temperature and was 37 wt.% of compound (i). The second fraction was collected at 30-35° C. and was pure product (i) confirmed by ¹H NMR. Total product collected in the two fractions was 4.81 g (28.2 mmol) in a yield of 85%. The second fraction was shown to be one species by GC/MS. ¹H NMR (CDCl₃) δ 2.9 ppm (br, 2H), 2.8 ppm (t, 2H), 1.6 ppm (quin, 2H), 0.7 ppm (t, 6H), 0.3 ppm (t, 2H), 0.2 ppm (quad, 4H).

### EXAMPLE 2

### Cure with diethyl(3-aminopropyl)borane

The following radical curable adhesive employed diethyl(3-aminopropyl)borane.

| | Wt. parts |
|---|---|
| tetrahydrofurfuryl methacrylate | 100 |
| elastomer toughener | 25 |
| diethyl(3-aminopropyl)borane | 3.75 |
| sulfonic acid deblocking agent | 2.5 |
| 0.25 mm dia. glass beads | ˜3 |

Untreated polypropylene coupons were bonded together in a single lap joint with a 1 in² (6.45 cm²) overlap. A weight of 170 grams was placed upon the bonded coupons. The samples were allowed to cure for 4 days and then were separated on an instrumented hydraulic tensile tester. The lap samples had a mean stress at break of 421 p.s.i. (2902 kPa) (standard deviation=40 p.s.i./ 276 kPa).

### EXAMPLE 3

### Synthesis of 2-(3-(B,B-diethylboranyl)propyl)pyridine

In an argon-filled glove box, a solution of 1.5 mL (1.5 mmol) of borane 1M solution in THF and 0.43 mL (0.29 g, 3.0 mmol) of triethylborane was prepared and equilibrated for five days at −10° C. The solution was removed from the freezer and 0.53 g (4.4 mmol) of 2-allylpyridine was added to the reaction incrementally with cooling. The reaction was stirred at room temperature for 24 hrs. The solvent was removed under vacuum (1 torr) to leave 0.66 g (3.5 mmol) of the desired product (78% yield). ¹H NMR (CDCl₃) δ 8.4 ppm (d, 1 H), 7.65 ppm (t, 1 H), 7.2 ppm (m, 2H), 2.85 ppm (t, 2H), 1.8 ppm (quin, 2H), 0.6 ppm (t, 8H), 0.4 ppm (m, 4H).

### EXAMPLE 4

### Cure with 2-(3-(B,B-diethylboranyl)propyl) pyridine

The following adhesive employed 2-(3-(B,B-diethylboranyl)propyl)pyridine:

| | Wt. parts |
|---|---|
| tetrahydrofurfuryl methacrylate | 100 |
| tetrahydrofurfuryl acrylate | 25 |
| methyl/n-butyl methacrylate copolymer | 31.2 |
| ABS impact mod. | 17.3 |
| 2-(3-(B,B-diethylboranyl)propyl) pyridine | 5.56 |
| methoxyethoxymethyl chloride | 10 |
| 0.25 mm dia. glass beads | ˜3 |

Polypropylene coupons were bonded together in a single lap joint with a 1 in² (6.45 cm²) overlap. A 170 g weight was placed upon the samples during curing for 3 days. The samples were separated on a hydraulic tensile tester. The samples had a mean stress at break of 47 p.s.i. (324 kPa) (standard deviation=16 p.s.i. /110 kPa).

### EXAMPLE 5

### Cure with diethyl(2-methyl-3-aminopropyl)borane

An adhesive containing 3.2 g THF-methacrylate, 0.8 g styrene-butadiene rubber, 0.135 g diethyl(2-methyl-3-aminopropyl)borane, and 0.078 g methane sulfonic acid was used to prepare five polypropylene lap shear samples (4″×1″×⅛″ coupons; 1 in² overlap, 10 mil glass beads for bond line control). The samples were held in place with 170 g weights and were allowed to cure for 24 hours. The samples were pulled on a tensile tester and had a mean stress at break of 300 p.s.i. (2068 kPa) (standard deviation=54 p.s.i.) (372 kPa).

### EXAMPLE 6

### Cure with diethyl(N-methyl-3-aminopropyl)borane

An adhesive containing 3.2 g THF-methacrylate, 0.8 g styrene-butadiene rubber, 0.17 g diethyl(N-methyl-3-aminopropyl)borane, and 0.10 g methane sulfonic acid was used to prepare five polypropylene lap samples (4″×1″×⅛″ coupons; 1 in² overlap, 10 mil glass beads for bond line control). The samples were held in place with 170 g weights and were allowed to cure for 24 hours. The samples were pulled on a tensile tester and had a mean stress at break of 251 p.s.i. (1730 kPa) (standard deviation=41 p.s.i.) (282 kPa).

### EXAMPLE 7

### Cure with diethyl(N,N-dimethyl-3-aminopropyl)borane

An adhesive containing 3.2 g THF-methacrylate, 0.8 g styrene-butadiene rubber, 0.186 g diethyl(N,N-dimethyl-3-aminopropyl)borane, and 0.10 g methane sulfonic acid was used to prepare five polypropylene lap samples (4″×1″×⅛″ coupons; 1 in² overlap, 10 mil glass beads for bond line control). The samples were held in place with 170 g weights and were allowed to cure for 24 hours. The samples were pulled on a tensile tester and had a mean stress at break of 468 p.s.i. (3226 kPa) (standard deviation=33 p.s.i.) (227 kPa).

### EXAMPLE 8

### Air Stability

Prior art organoborane amine complexes of triethylborane and either hexamethylene diamine, 4-aminopyridine, 4-N,N-dimethylaminopyridine, and tetramethylguanidine showed significantly more rapid oxidation in air in THF solutions as compared to the internally coordinated organoboranes: 3-aminopropyldiethylborane, 2-(3-(B,B-diethylboranyl)propyl)pyridine, diethyl(N,N-dimethyl-3-aminopropyl)borane, diethyl(N-methyl-3-aminopropyl)borane, which each showed little or no sign of decomposition by ¹H NMR after 15 days air exposure in THF. The improved air stability of diethyl(N,N-dimethyl-3-aminopropyl)borane is remarkable as compared to an externally blocked tertiary amine organoborane complex which is known to be pyrophoric in air.

It is understood that the foregoing description of preferred embodiments is illustrative, and that variations may be made in the present invention without departing from the spirit and scope of the invention. Although illustrated embodiments of the invention have been shown and described, latitudes of modification, change and substitution are intended in the foregoing disclosure, and in certain instances some features of the invention will be employed without a corresponding use of other features. Accordingly, it is appropriate that the appended claims are to be construed in a manner consistent with the scope of the invention.

What is claimed is:

1. A method for adhesively bonding two substrates, the method comprising the steps of:
(a) providing a first and a second substrate;
(b) applying to at least one of said first and said second substrates a mixture comprising:
(i) a radical polymerizable material;
(ii) an internally coordinated organoborane comprising nitrogen bonded to boron as part of a 5-, 6-, or 7-membered ring,
(iii) optional deblocking agent;
(c) mating the first and second substrates with said mixture in step (b) therebetween; and
(d) allowing the radical polymerizable material to polymerize, optionally with application of heat, whereby the first and second substrates are adhesively bonding.

2. The method according to claim 1 wherein the internally coordinated organoborane has the structure 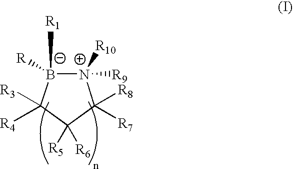
wherein R₁ and R₂ are independently selected from substituted or unsubstituted, linear or branched C₁-C₁₂ alkyl, phenyl, benzyl, C₁-C₈ linear or branched alkyl (mono-, di-, or tri-) substituted aryl;
R₉ and R₁₀ are independently hydrogen, C₁-C₆ substituted or unsubstituted, linear or branched alkyl groups, and R₃-R₈ are each independently hydrogen, substituted or unsubstituted C₁-C₁₂ alkyl, phenyl, C₁-C₈, linear or branched alkyl (mono-, di-, or tri-) substituted aryl group or a fused aromatic ring and n is 1, 2, or 3.

3. The method according to claim 1 wherein the internally coordinated organoborane has the structure 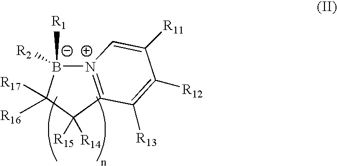
wherein R₁ and R₂ are independently selected from substituted or unsubstituted, linear or branched C₁-C₁₂ alkyl, phenyl, benzyl, C₁-C₈ linear or branched alkyl (mono-, di-, or tri-) substituted aryl;
and R₁₁-R₁₇ are each independently hydrogen, substituted or unsubstituted C₁-C₁₂ alkyl, phenyl, C₁-C₈, linear or branched alkyl (mono-, di-, or tri-) substituted aryl group or a fused aromatic ring, and n is 1, 2, or 3.

4. The method according to claim 1 wherein the internally coordinated organoborane has the structure 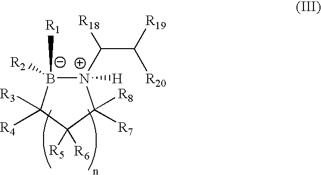
wherein R₁ and R₂ are independently selected from substituted or unsubstituted, linear or branched C₁-C₁₂ alkyl, phenyl, benzyl, C₁-C₈ linear or branched alkyl (mono-, di-, or tri-) substituted aryl;
and R₃-R₈ and R₁₈-R₂₀ are each independently hydrogen, substituted or unsubstituted C₁-C₁₂ alkyl, phenyl, C₁-C₈, linear or branched alkyl (mono-, di-, or tri-) substituted aryl group, a fused aromatic ring, and n is 1, 2, or 3.

5. The method according to claim 1 wherein the internally coordinated organoborane has the structure 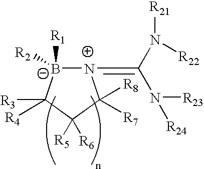
wherein R₁ and R2 are independently selected from substituted or unsubstituted, linear or branched C₁-C₁₂ alkyl, phenyl, benzyl, C₁-C₈ linear or branched alkyl (mono-, di-, or tri-) substituted aryl;
R₃-R₈ and R₂₁-R₂₄ are each independently hydrogen, substituted or unsubstituted C₁-C₁₂ alkyl, phenyl, C₁-C₈, linear or branched alkyl (mono-, di-, or tri-) substituted aryl group or a fused aromatic ring, and n is 1, 2, or 3.

6. The method according to claim 1 wherein the internally coordinated organoborane has the structure 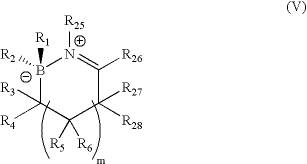
wherein R₁ and R₂ are independently selected from substituted or unsubstituted, linear or branched C₁-C₁₂ alkyl, phenyl, benzyl, C₁-C₈ linear or branched alkyl (mono-, di-, or tri-) substituted aryl;
and R₃-R₆ and R₂₅-R₂₈ are each independently hydrogen, substituted or unsubstituted C₁-C₁₂ alkyl, phenyl, C₁-C₈, linear or branched alkyl (mono-, di-, or tri-) substituted aryl group or a fused aromatic ring, and m is 1 or 2.

7. The method according to claim 1 wherein the internally coordinated organoborane has the structure 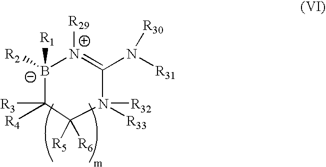
wherein R₁ and R₂ are independently selected from substituted or unsubstituted, linear or branched C₁-C₁₂ alkyl, phenyl, benzyl, C₁-C₈ linear or branched alkyl (mono-, di-, or tri-) substituted aryl; R₃₋₆ and R₂₉₋₃₃ are each independently hydrogen, substituted or unsubstituted C₁-C₁₂ alkyl, phenyl, C₁-C₈ linear or branched alkyl (mono-, di-, or tri-) substituted aryl group or a fused aromatic ring, and m is 1 or 2.

8. The method according to claim 1 wherein the internally coordinated organoborane has the structure 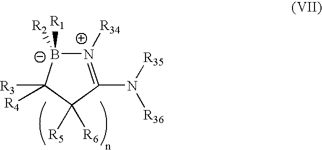
wherein R₁ and R₂ are independently selected from substituted or unsubstituted, linear or branched C₁-C₁₂ alkyl, phenyl, benzyl, C₁-C₈ linear or branched alkyl (mono-, di-, or tri-) substituted aryl; R₃₋₆ and R₃₄₋₃₆ are each independently hydrogen, substituted or unsubstituted C₁-C₁₂ alkyl, phenyl, C₁-C₈ linear or branched alkyl (mono-, di-, or tri-) substituted aryl group or a fused aromatic ring, and n is 1, 2, or 3.

9. The method according to claim 2 wherein R₁ and R₂ are independently selected from methyl, ethyl, propyl, and isopropyl, and R₉ and R₁₀ are H.

10. The method according to claim 1 wherein one or both of said first and said second substrates comprise materials selected from the group consisting thermoplastic polymers, thermoset polymers, metal, mineral, wood or glass.

11. The method of claim 9 wherein one or both of said substrates comprises a thermoplastic polymer containing repeating units from materials selected from the group consisting of ethylene, propylene, isocyanate, urea, dibasic acid, dihydric alcohol, fluoro-substituted olefin, vinylether, vinyl ester, diamine, vinyl compound, vinylidene compound.

12. The method according to claim 1 wherein said mixture further comprises (iv) an accelerator.

13. The method according to claim 1 wherein the radical polymerizable component comprises methacrylate ester selected from the group consisting of methyl methacrylate, ethyl methacrylate, butyl methacrylate, methoxy ethyl methacrylate, hydroxyethyl methacrylate, hydroxypropyl methacrylate, cyclohexyl methacrylate, tetrahydrofurfuryl methacrylate, 3,3,5-trimethyl cyclohexylmethacrylate and blends thereof.

14. The method according to claim 13 wherein the methacrylate ester monomer is methyl methacrylate, and said radical polymerizable component further comprises an alkyl acrylate.

15. The method according to claim 1 wherein said mixture further comprises a polymer-in-monomer syrup.

16. The method according to claim 1 wherein said mixture further comprises a toughener.

17. The method according to claim 1 wherein the internally coordinated organoborane has the structure:

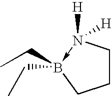

18. The method according to claim 1 wherein the internal organoborane has the structure:

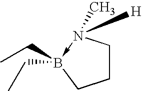

19. The method according to claim 1 wherein the internally coordinated organoborane has the structure:

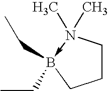

20. The method according to claim 1 wherein the internally coordinated organoborane has the structure:

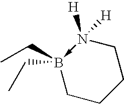

21. The method according to claim 1 wherein the internally coordinated organoborane has the structure:

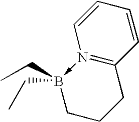

22. A two-part kit comprising:
(i) a radical polymerizable material in the first part; and
(ii) an internally coordinated organoborane comprising nitrogen bonded to boron as part of a 5-, 6-, or 7-membered ring in the second part.

23. The two-part kit according to claim 22 further comprising a deblocking agent in the first part.

24. The two-part kit according to claim 22 further comprising a radical polymerizable material in the second part.

25. The two-part kit according to claim 23 further comprising radical polymerizable material in the second part.

26. The two-part kit according to claim 22:
wherein the internally coordinated organoborane has a structure selected from (I)-(VII) 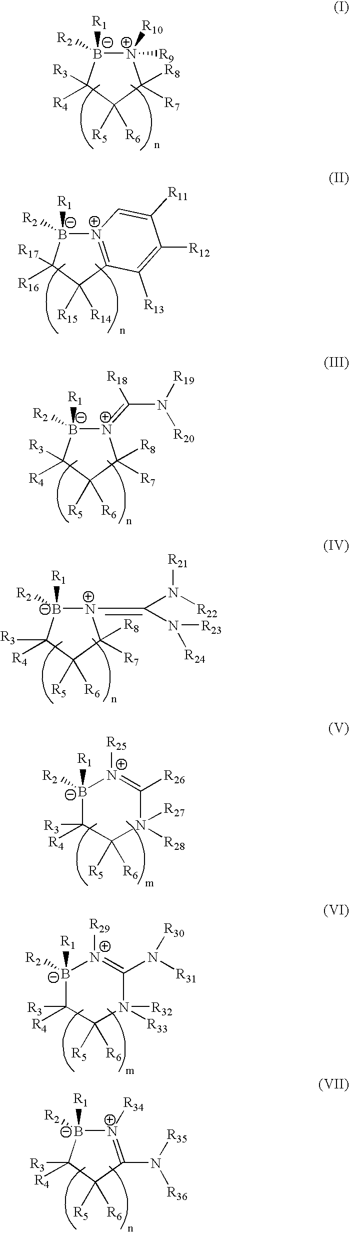
wherein n is 1, 2, or 3; m is 1 or 2; R₁ and R₂ are independently selected from substituted or unsubstituted, linear or branched C₁-C₁₂ alkyl, phenyl, benzyl, C₁-C₈ linear or branched alkyl (mono-, di-, or tri-) substituted aryl;
R₉ and R₁₀ are independently hydrogen, substituted or unsubstituted C₁-C₆ linear or branched alkyl groups;
R₃-R₆ and R₃₄-R₃₆ are each independently hydrogen, substituted or unsubstituted C₁-C₁₂ alkyl, phenyl, C₁-C₈, linear or branched alkyl (mono-, di-, or tri-) substituted aryl group or a fused aromatic ring; and
optionally a deblocking agent in the part which does not contain said internally coordinated organoborane.

27. The kit according to claim 22 wherein the polymerizable material is a monoethylenic unsaturated methacrylate ester.

28. The kit according to claim 27 wherein the monofunctional methacrylate ester is selected from the group consisting of methyl methacrylate, ethyl methacrylate, butyl methacrylate, methoxy ethyl methacrylate, hydroxyethyl methacrylate, hydroxypropyl methacrylate, cyclohexyl methacrylate, tetrahydrofurfuryl methacrylate, 3,3,5-trimethyl cyclohexylmethacrylate and blends thereof.

29. The kit according to claim 23 wherein the deblocking agent is selected from dichloroacetic acid, trichloroacetic acid, methanesulfonic acid, toluene sulfonic acid, oxalic acid, maleic acid, and p-methoxybenzoic acid, BF₃ and lanthanum triflate.

30. The kit according to claim 26 wherein the composition comprises about 1.5 to 6 mol % of one of (I)-(VII) on total wt of radical polymerizable material.

31. An internally coordinated organoborane having a structure (I)-(VII) 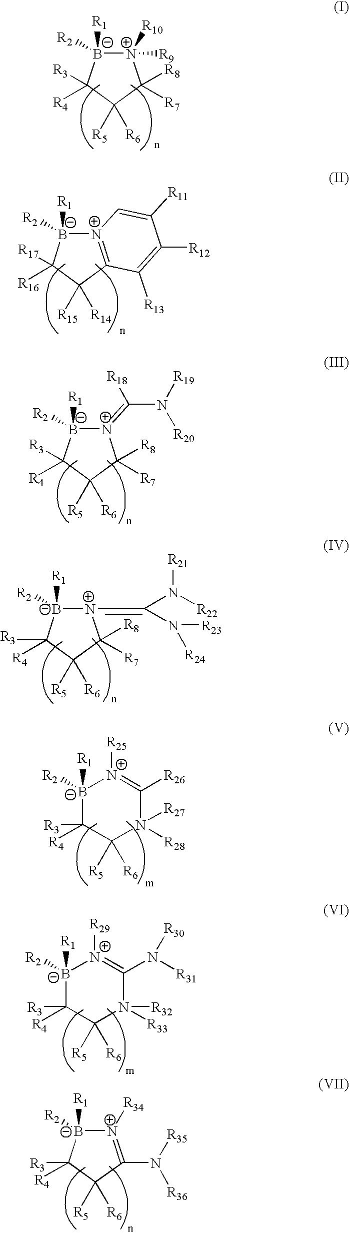
wherein n is 1, 2, or 3; m is 1 or 2; R₁ and R₂are independently selected from substituted or unsubstituted, linear or branched C₁-C₁₂ alkyl, phenyl, benzyl, C₁-C₈ linear or branched alkyl (mono-, di-, or tri-) substituted aryl;
R₉ and R₁₀ are independently hydrogen, substituted or unsubstituted C₁-C₆ linear or branched alkyl groups, with the proviso in (I) where n=1, at least one of R₉ and R₁₀ is H and the other is a C₁-C₆ substituted or unsubstituted linear or branched alkyl group;
R₃-R₆ and R₃₄-R₃₆ are each independently hydrogen, substituted or unsubstituted C₁-C₁₂ alkyl, phenyl, C₁-C₈, linear or branched alkyl (mono-, di-, or tri-) substituted aryl group or a fused aromatic ring.

32. The internally coordinated organoborane according to claim 31 having the structure (I) wherein n=1 or 2, R₁ is ethyl, R₂ is ethyl, R₉ and R₁₀ are independently H, or substituted or unsubstituted C₁-C₆ linear alkyl group.

33. The internally coordinated organoborane according to claim 31 having the structure (I) wherein n=1, R₁ is ethyl, R₂ is ethyl, R₉ and R₁₀ are H.
